(19) United States
(12) Patent Application Publication
(10) Pub. No.: US 2011/0019045 A1
(43) Pub. Date: Jan. 27, 2011

(54) METHOD AND APPARATUS FOR SIMULTANEOUS ELECTRONIC SHUTTER ACTION FRAME STORAGE AND CORRELATED DOUBLE SAMPLING IN IMAGE SENSOR

(76) Inventor: Chi-Shao Lin, Grand Cayman (KY)

Correspondence Address: NORTH AMERICA INTELLECTUAL PROPERTY CORPORATION, P.O. BOX 506, MERRIFIELD, VA, 22116, US

(21) Appl. No.: 12/509,483

(22) Filed: Jul. 26, 2009

(51) Int. Cl. H04N 5/335

(52) U.S. Cl. 348/296; 348/294; 348/E05.091

(57) ABSTRACT

An electronic image sensor with a pixel array of a plurality of active pixels is provided. Each of the active pixels includes: a photo detector, providing a sensing node for producing a signal based on an amount of light incident thereon; a storing node for storing a plurality of photo-generated charges according to the signal; a first controllable potential barrier between the sensing node and the storing node; an outputting node; and a second controllable potential barrier between the storing node and the outputting node, wherein each of the sensing node, the storing node and the sampling node is not overlapped.

### BACKGROUND OF THE INVENTION

1. Field of the Invention

The present invention relates to CMOS sensors, and more particularly, to a method and apparatus for providing simultaneous electronic shutter action (SESA) frame storage and correlated double sampling (CDS) simultaneously in the CMOS sensors.

2. Description of the Prior Art

Digital cameras are commonly used today. Typically, a digital camera contains image sensors for converting light into electrical charges. Generally, image sensors can be divided into two broad categories according to the applied manufacturing process: CCD (charge-coupled device) sensors and CMOS (Complementary Metal Oxide Semiconductor) image sensors, where the CMOS image sensors (CIS) are based on the CMOS technologies.

For CMOS image sensors, a pixel is an element of an image sensor implemented for generating a differentiable strength output signal; the differentiable strength output signal is proportional to the strength of incident light. Each pixel within the image sensor is also implemented for detecting, storing, and outputting a signal. Typically, CMOS sensors use an “active pixel” for image sensing rather than use a “passive pixel” within. In brief, a pixel with an amplifier or signal buffer is called an “active pixel”, while a pixel with only a photo detector and a switch is defined as a “passive pixel”. With regards to a typical “active pixel” CMOS image sensor, each active pixel contains a photodiode for sensing light and a parasitic capacitor for holding the received signal.

Please refer to FIG. 1. FIG. 1 is a diagram illustrating a conventional structure of an active pixel. As shown in FIG. 1, an active pixel 100 contains three nodes 101, 103 and 105. The node 101 is a detecting node for detecting a signal; the node 103 is a storing node for storing the signal; and the node 105 is a sampling node for outputting the signal. In different cases, the detecting node (i.e., node 101), storing node (i.e., node 103) and sampling node (i.e., node 105) can be overlapped (e.g., using only one node for executing the three functions) or separated, depending on different design requirements of image sensors.

In FIG. 1, the active pixel 100 further contains an amplifier (AMP) 106, where the amplifier 106 (e.g., an in-pixel amplifier) amplifies the sampled signal from the sampling node (i.e., the node 105) to thereby generate an output 107. The output 107 is then sent to other circuitry in a digital camera (not shown) for follow-up processes. In addition, the active pixel 100 shown in FIG. 1 can further contain two gateways 102 and 104, coupled between the nodes 101 and 104 and coupled between the nodes 103 and 105 respectively. As active pixel gateways are known to those skilled in this art, further description is omitted here for brevity.

For CMOS image sensors with active pixels, correlated double sampling (CDS) is often adopted to eliminate a low-frequency noise within the CMOS image sensors. The operating scheme of the CDS operation is described as follows.

For the CDS operation, at time t=t₁, a first voltage signal readout vₒᵤₜ₁=vₙ₁ is obtained, where Vₙ₁ illustrates noise at the sampling node (i.e., the node 105). At time t=t₂=t₁+Δt, a signal is added to the sampling node (i.e., the node 105), and then a second signal readout, i.e., vₒᵤₜ₂=vₙ₂+v_{sig} is obtained immediately. That is, in the CDS operation, the first readout is for capturing noise, and the second readout is for capturing both the undesired noise (Vₙ₂) and the demanded signal (V_{sig}).

Thereafter, the CDS operation extracts the demanded signal by subtracting the first sampled value derived from the first signal readout from the second sampled value derived from the second signal readout. The extracted signal ΔVout hence can be represented as below:

Δvₒᵤₜ=vₒᵤₜ₂−vₒᵤₜ₁=(vₙ₂+v_{sig})−(vₙ₁)=(vₙ₂−vₙ₁)+v_{sig}

In a case where the low-frequency noise dominates and Δt is small enough, a value (vₙ₂−vₙ₁) at this time will be close to zero, thus achieving a desired output: Δvₒᵤₜ≅v_{sig}.

That is, the CDS operation acts as a high-pass filter for filtering out undesired low-frequency noise. The smaller the value of Δt; the higher the cutoff frequency, which further suppresses noise. The Δt between two readouts should be as small as possible. Typically, for an effective CDS in an image sensor with active pixels, Δt should be in the order of a few microseconds or smaller. However, for an active pixel to perform the CDS function, two separated storing nodes for signal storage are necessary, although one of the storing nodes may simultaneously have other functions, e.g., signal detecting or sampling. In addition, a complete CDS readout also requires CDS operation in the readout circuitry, which adds its own noise to the data.

Please refer to FIG. 2; FIG. 2 is a diagram illustrating a typical electronic image sensor 200. As shown in FIG. 2, the electronic image sensor 200 contains a pixel array 210 (i.e., the pixel array 210 has M*N pixels 215 arranged in a matrix format with N rows 214 and M columns 216) and M column processors 220 coupled to M columns 216 respectively. Due to the column processors 220 are only capable of processing one row 214 at a time, a scheme for only executing a reset operation or a readout operation at a time is adopted in such an electronic image sensor (e.g., the electronic image sensor 200 shown in FIG. 2), where the scheme is usually called “rolling” reset and readout scheme. In general, each readout operation of one individual row 214 usually takes more than a few microseconds. As a result, an image sensor with 1000 rows takes more than a few milliseconds for successfully getting readout data of a full frame. However, the very long required time creates artifacts on moving object images and further results in image blurring. These effects are not desirable for modern digital cameras (i.e., electronic image sensors) and other imaging equipment.

In face, it is preferable in most cases to perform a snapshot operation and a simultaneous electronic shutter action (SESA) operation. The “snapshot” function synchronizes all pixels in an image sensor to simultaneously start and stop exposure. The process to achieve higher shutter speed in an electronic image sensor by controlling the start and stop of integration (exposure) is called “Simultaneous Electronic Shutter Action (SESA)”. The SESA operation ensures that all pixels capture the image of a scene at the very same moment. Unfortunately, the designs of the existing CMOS image sensors can not provide both a complete CDS function and the SESA functionality simultaneously. As mentioned above, there are a plurality of different structures of APS pixel, such as 3T APS pixel, 4T APS pixel (e.g., a photogate APS), 5T APS pixel, etc. depending on design requirements. Descriptions for these different APS pixels are as follows.

Please refer to FIG. 3; FIG. 3 is a diagram illustrating a conventional structure of a 3T APS (active pixel structure) pixel 300. In FIG. 3, the 3T active pixel 300 contains three transistors 306, 309 and 310 and the 3T active pixel 300 possesses a non correlated double sampling functionality. Here the node 308 is implemented for executing all the detecting, storing and outputting operations. Please note that, the 3T APS pixel 300 has more elements; however, since the structure of the 3T APS pixel is known to those skilled in this art, further description is omitted here.

Please refer to FIG. 4 in conjunction with FIG. 3. FIG. 4 is a timing diagram illustrating a plurality of signals of a CMOS image sensor containing N rows of the 3T APS pixels 300 in a pixel array. As shown in FIG. 4, the pixel array of the CMOS image sensor in this case operates in a “rolling row” manner, where the rolling manner has been explained in the above descriptions of rolling reset and readout operation. The timing signals for a row therefore resemble the predecessor row, but are delayed by one row at a given time. As shown in FIG. 4, for each row of the pixel array to execute a non-correlated double sampling functionality, there are two timing signals, including a reset signal and a row select signal. For instance, in FIG. 4, an operation of a row 1 within the pixel array is described as follows, where the CMOS image sensor here employs 3T active pixels 300. The operation flow for one row includes the following steps:

Step 1: For the row 1 as shown in FIG. 4, firstly a reset operation is executed. The node 308 (as shown in FIG. 3) is reset via turning on the reset transistor 310 (a pulse 1 of a reset signal 310A occurs in FIG. 4), then turns off the Reset transistor 310 in FIG. 3 to start a charge integration during the integration time such that: v₁(1)=vᵣₑₛₑₜ₁+vₙ₁, where the voltage V₁(1) is an extracted voltage expressed a noise level signal (FIG. 4), and the reset signal 310A expressed the voltage signal applied to the gate terminal of the reset transistor 310.

Step 2: The CMOS image sensor executes a first readout operation for the row 1 to sample (signal+noise) level, thereby extracting a rudimentary output voltage Vₒᵤₜ₁: vₒᵤₜ₁=v₁(2)=vᵣₑₛₑₜ₁+vₙ₁+v_{sig}. The voltage Vₒᵤₜ₁ (i.e., V₁(2)) represents an extracted voltage when turning on the row select transistor 306 (a pulse 2 of the row select signal 306A in FIG. 4).

Step 3: A second reset operation is executed for the node 308 via turning on the reset transistor 310 (i.e., a pulse 3 of the reset signal 310A occurs) to thereby extracts a voltage: v₁(3)=vᵣₑₛₑₜ₂+vₙ₂, where the voltage V₁(3) represents the extracted voltage at this time.

Step 4: A second readout operation is executed for completing an operation cycle of one particular row (e.g., the row 1 in this case). The second reset level is sampled in the second readout operation, hence: vₒᵤₜ₂=vᵣₑₛₑₜ₂+vₙ₂, where the voltage Vₒᵤₜ₂ represents an extracted voltage via turning on the row select transistor 306 (i.e., a pulse 4 of the row select signal 306A occurs in FIG. 4).

The above four steps complete an operation cycle for one certain row in one frame. With the execution of aforementioned steps 1-4, an output of a pixel can be extracted as:

vₒᵤₜ=vₒᵤₜ₁−vₒᵤₜ₂=v_{sig}+(vᵣₑₛₑₜ₁−vᵣₑₛₑₜ₂)+(vₙ₁−vₙ₂).

In general, vᵣₑₛₑₜ₁−vᵣₑₛₑₜ₂≈0, but (vₙ₁−vₙ₂)=\sqrt{2}·\tilde{v}ₙ (\tilde{v}ₙ is the root-mean-square noise value), due to the fact that two samples (readouts) are not correlated to each other. Therefore, a final output of non correlated double sampling functionality in FIG. 4 becomes: vₒᵤₜ=v_{sig}+\sqrt{2}·\tilde{v}ₙ.

The 3T APS pixel 300 has some unwelcome drawbacks due to no true CDS (correlated double sampling) operation. This is because there being only one node 308 for signal detection, storage and sampling; once a charge integration of pixels in a row ends at the first readout, the subsequent second reset then destroys the signal.

Please refer to FIG. 5; FIG. 5 illustrates one conventional structure of 4T APS pixel 500. Compared with FIG. 3, the 4T APS Pixel 500 has one node for both signal detecting and storing, and another node 504 for signal sampling. The pixel array, however, still has to operate in a “rolling row” manner.

Please refer to FIG. 6 in conjunction with FIG. 5. FIG. 6 is a timing diagram for the photogate APS pixel 500 in FIG. 5. Here the 4T APS pixel 500 has a true CDS functionality, and operates according to a reset signal 310A of a reset transistor 310 (FIG. 5), a row select signal 306A for a row select transistor 306 (FIG. 5), a photodiode signal 502A for a photodiode 502 (FIG. 5), and a transmit signal 503A for a transfer gate (FIG. 5), whenever with appropriate adjustments the photodiode 502 can be replace by a photogate. In this case, a voltage of the photodiode signal 502A increases to start a charge integration after a reset operation for the sampling node 504 finishes. Before charge integration stops, the reset transistor 310 turns on for resetting the sampling node 504. The induced noise is left at the sampling node 504.

During the first read out operation, a noise is sampled accordingly as: vₒᵤₜ₁=vᵣₑₛₑₜ+vₙ₁. Then, a voltage of the transmit signal 503A rises to turn on the transfer transistor 503 and a voltage of the photodiode signal 502A falls, and the charges stored underneath the photodiode 502 are transferred to the sampling node 504. The second readout (i.e., signal+noise) is sampled as: vₒᵤₜ₂=v_{sig}+vᵣₑₛₑₜ+vₙ₁. In this way, the output can be extracted from the two corrected samples (readouts) as: vₒᵤₜ=vₒᵤₜ₂−vₒᵤₜ₁=v_{sig}.

By applying the 4T APS pixels 500 with the CDS operation to the CMOS image sensor, the low-frequency noise hence is removed. However, the CMOS image sensor with a pixel array of a plurality of 4T APS pixels 500 still lack SESA operation since the same node is used for both signal detecting and storing.

Please refer to FIG. 7. FIG. 7 is a diagram illustrating a structure of an APS pixel 800 with a SESA function according to the prior art. The structure of the APS pixel 800 has been disclosed in “A Snapshot CMOS Active Pixel Imager for Low Noise, High Speed Imaging”, IEEE Meeting in 1998, by Guang Yang et al., which has two transfer transistor(i.e., TX1 and TX2) and a charge sink 802 to achieve the SESA operation. In FIG. 7, the APS pixel 800 has a reset transistor 310, a row select transistor 306, a source follower 501, a first transfer transistor TX1 and a photodiode 502. In the APS pixel 800, the storing node and the sampling nodes overlap at a single node (i.e., the node 806). Hence, the collected charges are immediately transferred to a floating diffusion node (i.e., node 806) serving as the storing node and sampling node concurrently after charge integration stops. However, the APS pixel 800 has no CDS functionality and the quantum efficiency of the APS pixel 800 is still low, especially in blue light.

Generally, for achieving the aforementioned SESA operation, an APS pixel has to hold “exposure data” until it is read out. Nevertheless, a required data holding time could be as long as tens of milliseconds. Because electronic imaging systems do not have a mechanical shutter, the incoming light continues to generate charges during this period. A simple charge sink commonly seen in a pixel consists of a high-voltage source as a drain for electrons (or low-voltage source for holes), and a switch that connects this voltage source to a sensing node.

Yet another prior art structure of an APS pixel with the SESA operation is disclosed in U.S. Pat. No. 6,369,853 (Merrill et al.). In Merrill's disclosure, a reset switch and a reset voltage reset the photodiode before integration, and serve as a charge sink while holding signal. However, the structure taught by Merrill again lacks CDS capability.

As discussed above, the conventional systems have drawbacks. Therefore, there is a demand for providing a process and a system that allows both efficient CDS and SESA operation in the CMOS environment for digital cameras for better performances.

### SUMMARY OF THE INVENTION

In one exemplary embodiment of the present invention, an electronic image sensor with a pixel array of a plurality of active pixels is provided. Each of the active pixels includes: a photo detector, providing a sensing node for producing a signal based on an amount of light incident thereon; a storing node for storing a plurality of photo-generated charges according to the signal; a first controllable potential barrier between the sensing node and the storing node; a outputting node; and a second controllable potential barrier between the storing node and the outputting node, wherein each of the sensing node, the storing node and the outputting node is not overlapped.

In another exemplary embodiment of the present invention, a method for correlated double sampling (CDS) in an electronic image sensor with a pixel array of a plurality of active pixels where each active pixel has a photo detector for producing a signal based on an amount of light incident on the pixel array is provided. The method includes: integrating a plurality of photo-generated charges according to the signal; resetting a signal sampling node; sampling noise at a first readout; transferring the photo-generated charges to the signal sampling node; and obtaining a second read out with charge sampling to extract a signal accordingly.

In yet another exemplary embodiment of the present invention, a method is provided for correlated double sampling and “snapshot and simultaneous electronic shutter action (SESA)” in an electronic image sensor with a pixel array of a plurality of active pixels where each active pixel has a photo detector for producing a signal based on an amount of light incident on the pixel array. The method includes: integrating a plurality of photo-generated charges according to the signal; holding the photo-generated charges until a readout; turning on a charge sink for draining a plurality of incoming photo-generated charges; resetting a signal sampling node; sampling noise at a first readout; transferring the photo-generated charges to the signal sampling node; and turning off a charge sink for pre-resetting a plurality of nodes.

In yet another exemplary embodiment of the present invention, an

imaging system with an electronic image sensor having a pixel array of a plurality of active pixels is provided. Each of the active pixels includes: a photo detector, providing a sensing node for producing a signal based on an amount of light incident thereon; a storing node for storing a plurality of photo-generated charges according to the signal; a first controllable potential barrier between the sensing node and the storing node; an outputting node; and a second controllable potential barrier between the storing node and the outputting node, wherein each of the sensing node, the storing node and the outputting node is not overlapped.

According to one aspect of the present invention, a pixel with a plurality of separated nodes for signal detecting, storing and sampling, and further with a charge sink is provided. The pixel is capable of efficiently performing SESA in the CMOS sensor.

According to another aspect of the present invention, a pixel capable of performing Correlated Double Sampling (CDS) by using a “spill well” structure is provided. The photo detector of the present invention has higher quantum efficiency than those employing CCD and photogate types of pixels.

According to yet another aspect of the present invention, a pixel and an area-array of such a pixel as an image sensor capable of performing both SESA and CDS at the same time are provided. Also, the spill well structure that uses a photodiode as the photo detector helps to achieve higher quantum efficiency than those employing CCD and photogate pixels. Furthermore, the present invention is compatible with a standard CMOS process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit, the invention. The drawings include the following figures:

FIG. 1 is a diagram illustrating a conventional structure of an active pixel.

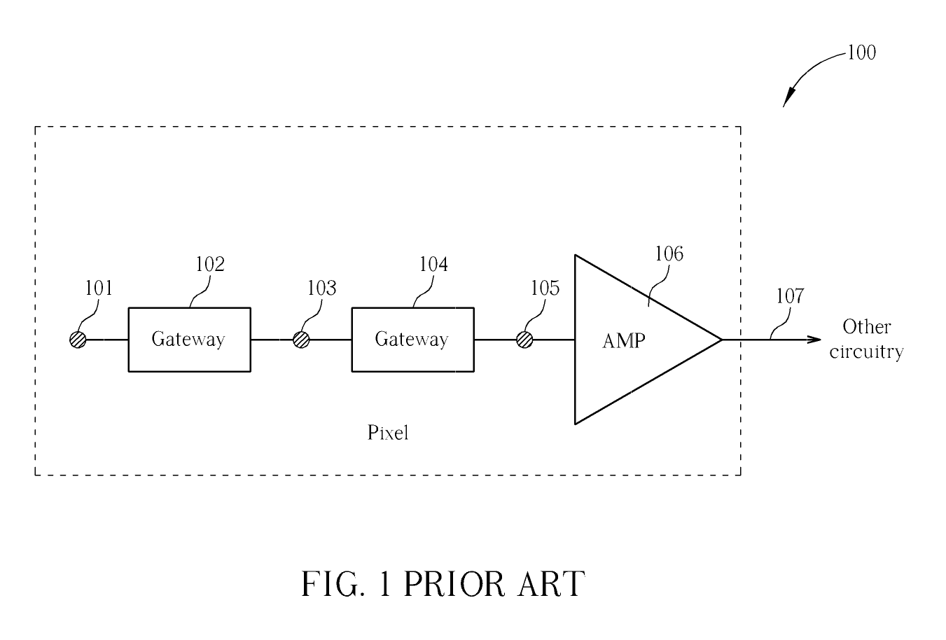

FIG. 2 is a diagram illustrating a typical electronic image sensor.

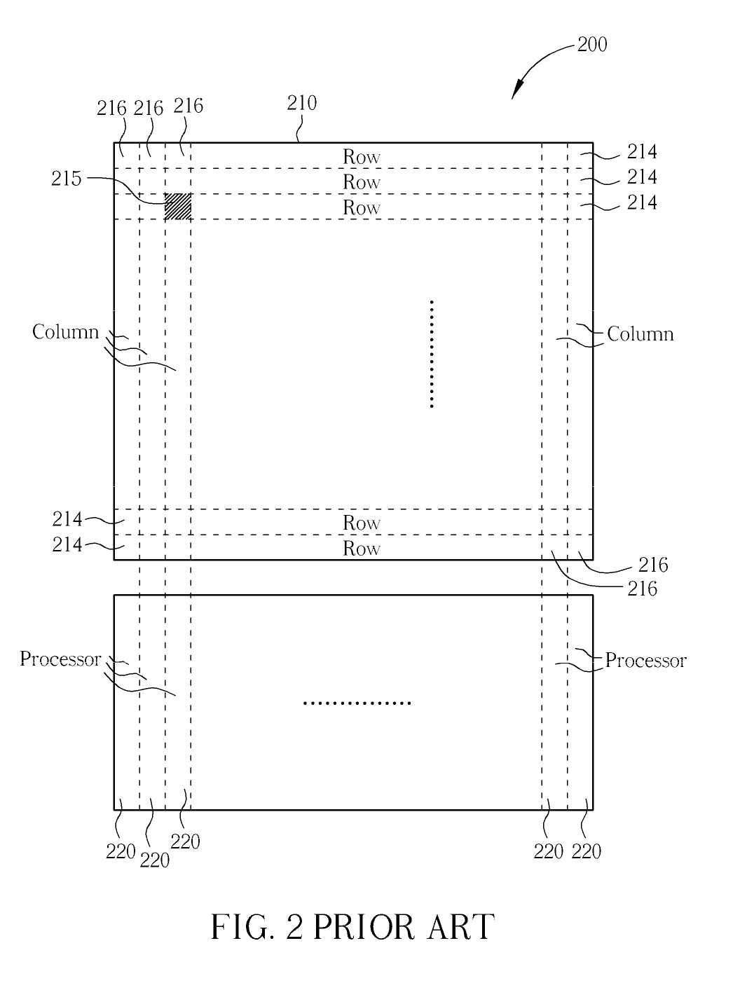

FIG. 3 is a diagram illustrating a conventional structure of a 3T APS (active pixel structure) pixel.

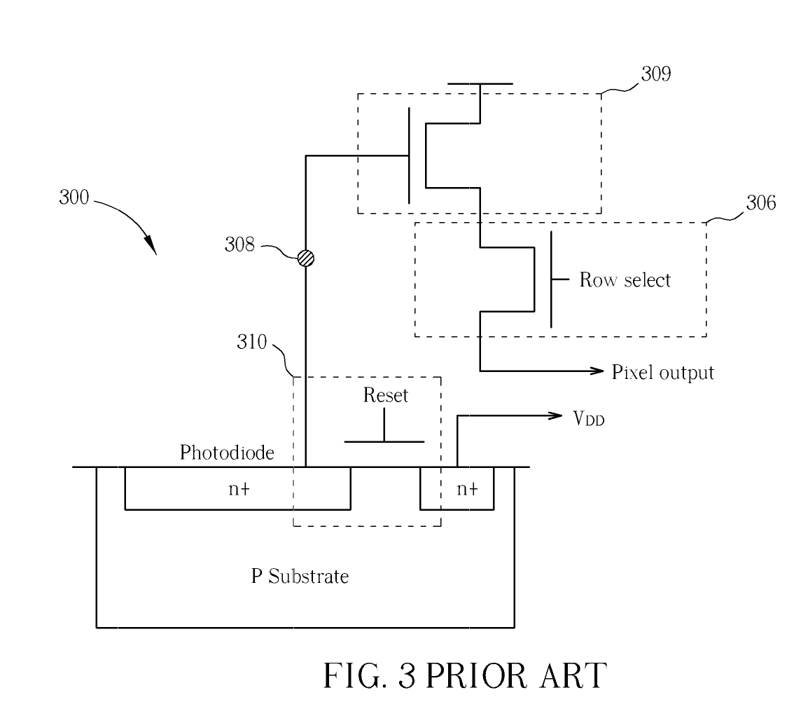

FIG. 4 is diagram illustrating a timing diagram for a plurality of signals of a CMOS image sensor containing N rows of the 3T APS pixels in FIG. 3.

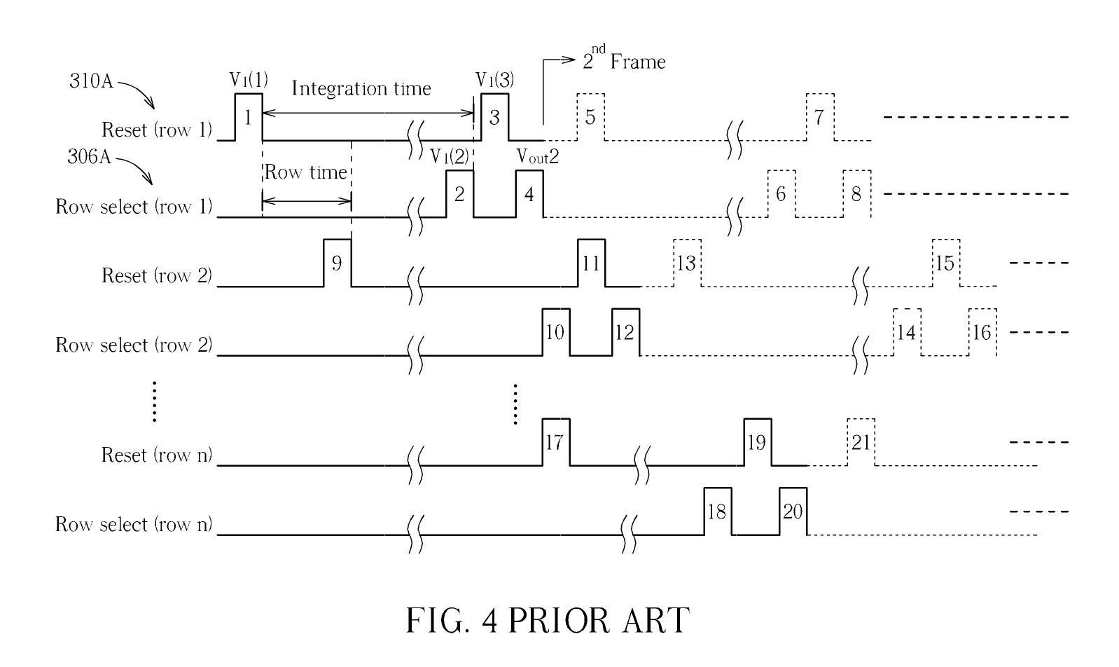

FIG. 5 is a diagram illustrating a conventional structure of a 4T APS (active pixel structure) pixel.

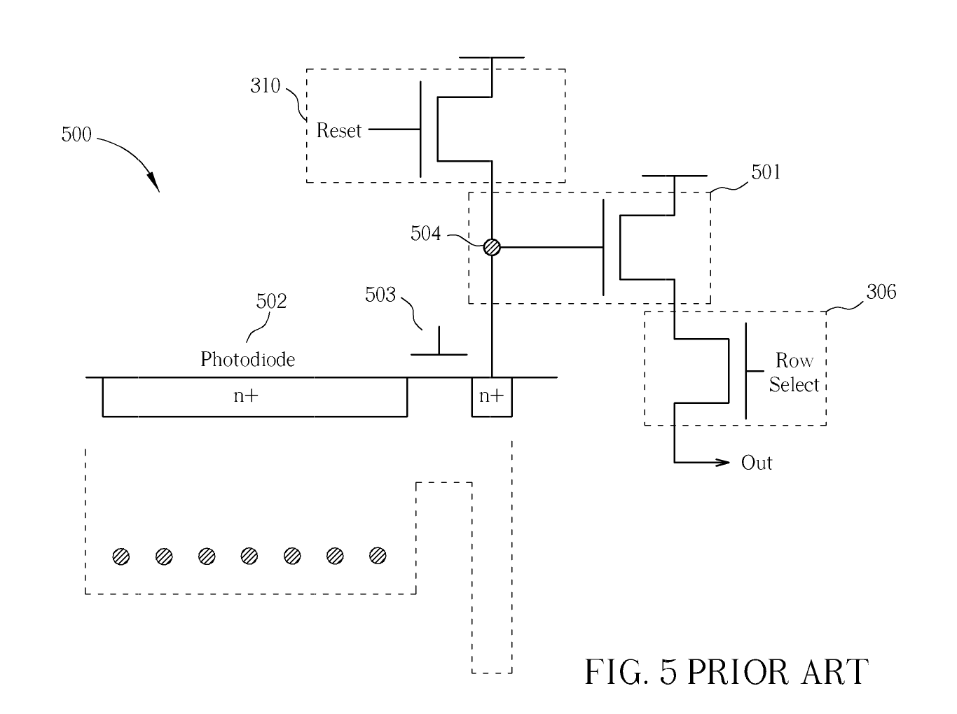

FIG. 6 is a timing diagram for the 4T APS pixel for a plurality of signals of a CMOS image sensor containing N rows of the 4T APS pixels in FIG. 5.

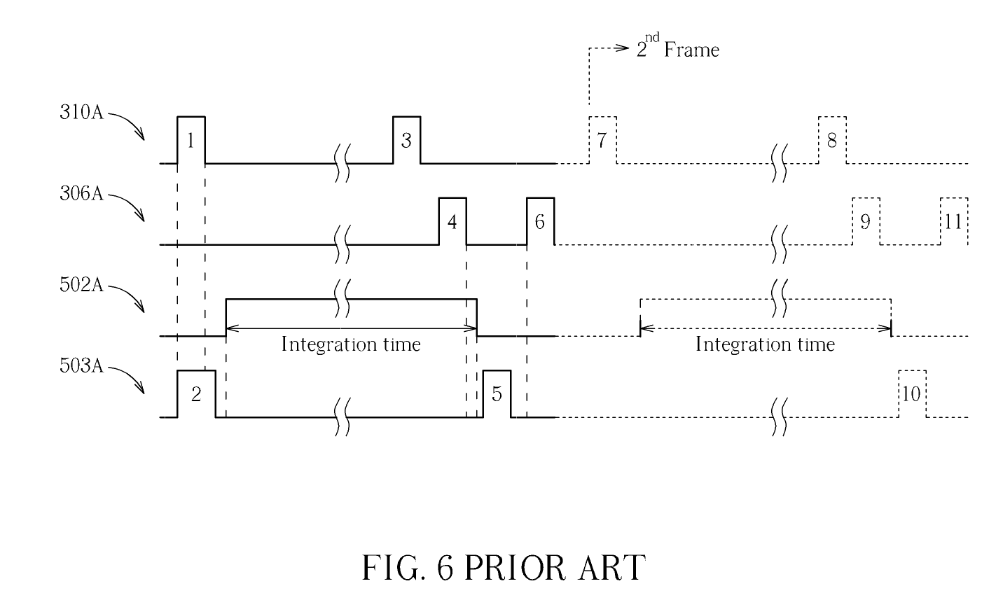

FIG. 7 is a diagram illustrating a conventional structure of an APS pixel with a SESA functionality.

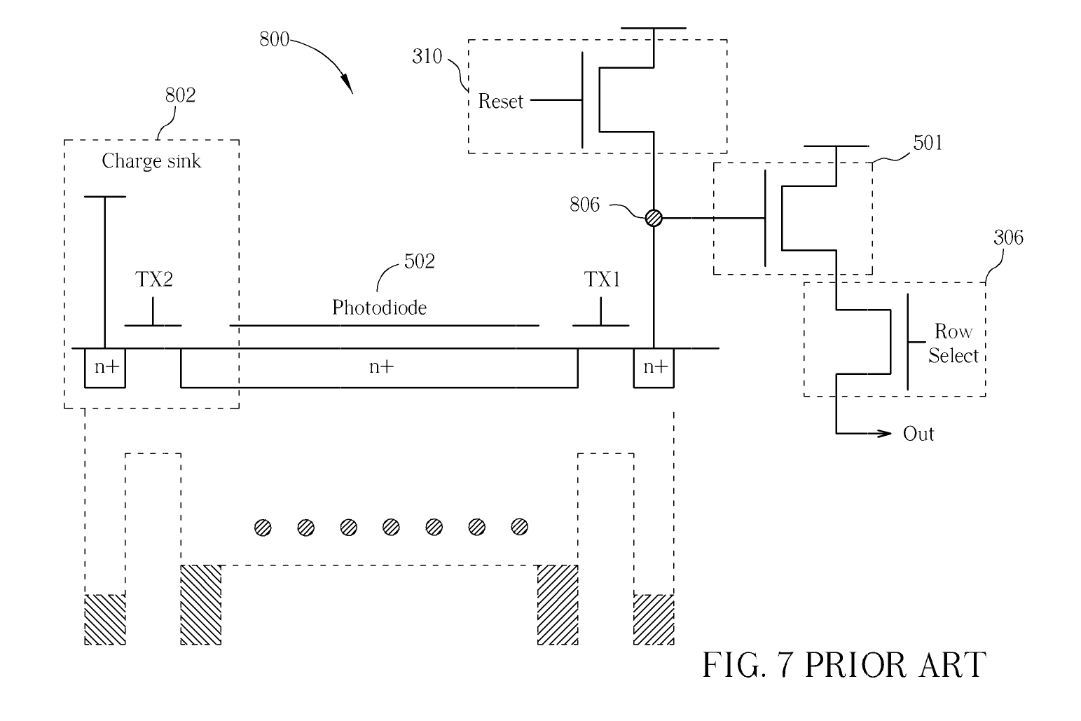

FIG. 8 is a block diagram illustrating a structure of an active pixel according to one exemplary embodiment of the present invention.

FIG. 9 is a diagram illustrating various steps of the active pixel shown in FIG. 8 to operate without SESA.

FIG. 10 is a timing diagram illustrating a plurality of signals according to an embodiment of the active pixel shown in FIG. 8 with respect to the process steps shown in FIG. 9.

FIG. 11 is a diagram illustrating various steps that may be used for the active pixel shown in FIG. 8 to operate with both the CDS function and the SESA function according to one exemplary embodiment of the present invention.

FIG. 12 is a timing diagram illustrating a plurality of signals according to an embodiment of the active pixel shown in FIG. 8 with respect to the process steps shown in FIG. 11.

FIG. 13 is a diagram illustrating various steps for simultaneously performing SESA and CDS functions according to one exemplary embodiment of the present invention.

### DETAILED DESCRIPTION

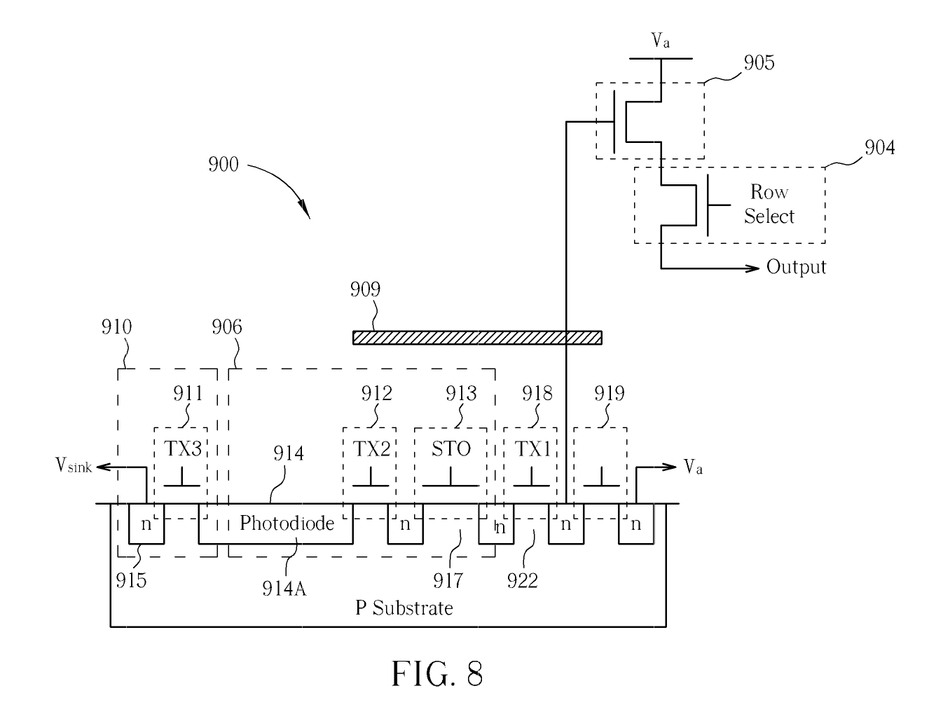

Please refer to FIG. 8. FIG. 8 is a diagram illustrating a structure of an active pixel 900 according to one exemplary embodiment of the present invention. In FIG. 8, the active pixel 900 includes a plurality of transistors acting as switches, a light shield 909 and a fully depleted photodiode 914, as described below. By the transistors, the active pixel 900 with separated sensing node, storing node, and outputting node for achieving the simultaneously electronic shutter action (SESA) and the correlated double sampling (CDS) functions. Please note the configuration of FIG. 8 is for illustrative purposes only and not meant to be a limitation. For instance, the row select transistor 904 is optional, and so as the light shield 909, the optional elements can be omitted depending on different design requirements. Furthermore, for the efficiency consideration, a fully depleted photodiode is used rather than the conventional photogate, however, with appropriate adjustments; the active pixel 900 can use the conventional photogate and/or photodiode to replace the fully depleted photodiode 914 to achieve the novel active pixel with both SESA and CDS functionalities simultaneously; the aforementioned design variances obey and fall in the scope of the present invention.

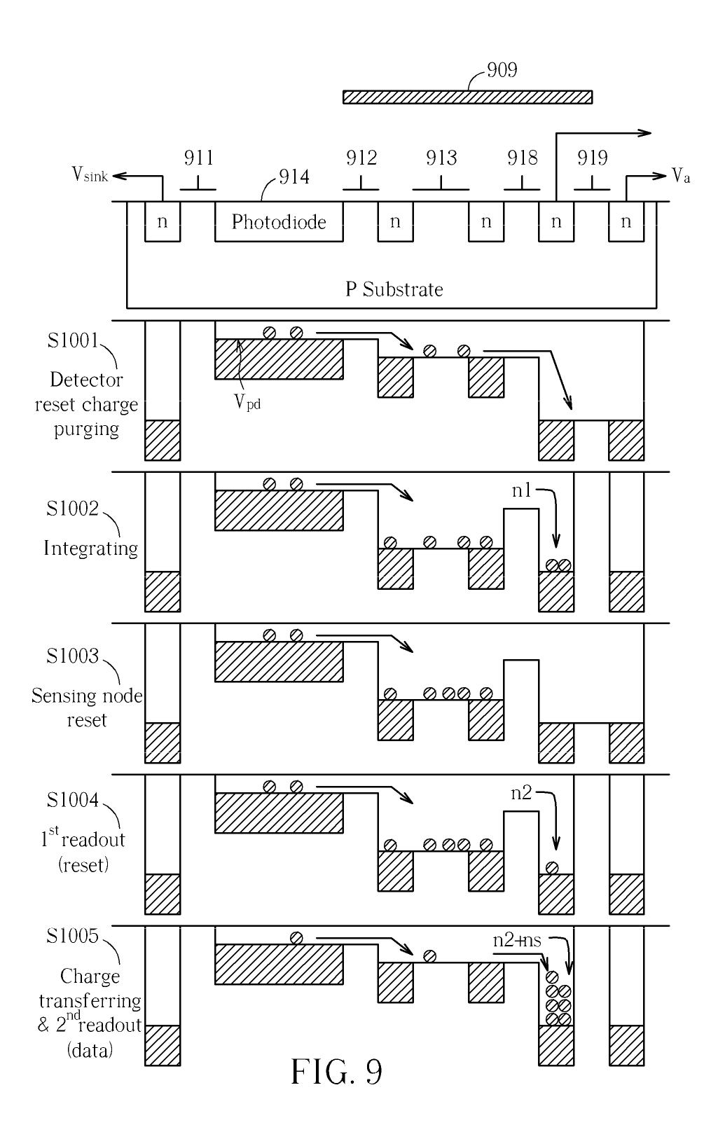

In this embodiment, the active pixel 900 includes a charge sink 910, wherein the charge sink 910 contains a transistor 911 (TX3) that creates a potential barrier between a photo detecting node 914A and a charge drain 915. The active pixel 900 further includes a spill well structure 906 that contains a transistor 912 (TX2) implemented for creating a potential barrier between the photo detecting node 914A and a storing node 917. A transistor 918 (TX1) forms a potential barrier between the storing node 917 and a outputting node 922; and a transistor 919, serving as a reset transistor, switches between the outputting node 922 and a reset voltage Vₐ. In addition, a transistor 905 is implemented to act as a source-follower amplifier for signal buffering. In FIG. 9, a row select transistor 904 is coupled to an output bus of the pixel array, and operates as a switch for row selection in a pixel array.

In FIG. 9, the voltage Vₐ can be a constant voltage or vary under different operations according to different design requirements. For instance, a plurality of the active pixels 900 can share a single transistor 911 (TX3), a single source follower 905, a single voltage node Vₐ, and a single voltage node Vₛᵢₙₖ to diminish the required cost and the circuit area. When the voltage Vₐ is allowed to vary under different steps, different APS pixels 900 can further share a single row select transistor 904 in a pixel array. However, please note, the row select transistor 904 is an optional element, and can be omitted in other embodiment. The alternative designs obey and fall into the scope of the present invention.

In this embodiment, the voltage Va is set to be less than or identical to a voltage V_{DD}, and a voltage Vₛᵢₙₖ is preferably greater than a voltage applied to the transistor 911 (TX3). In one aspect, the voltage Vₛᵢₙₖ is at least one transistor threshold voltage greater than the voltage applied to the transistor 911 (TX3). That is, the voltage Vₛᵢₙₖ can be set as a high voltage V_{DD} since it is used as a charge sink.

In different embodiments, the active pixel 900 may be constructed using n-type or p-type semiconductor transistors with appropriate adjustments according to the design requirements. It is noteworthy that the polarity described above (FIG. 9) will be reversed in the case of a p-type transistor. The light shield 909 in FIG. 9 is formed by one or more opaque layers on the transistor 913 to prevent stored pixel charges from being discharged. In addition, when the SESA function is not required in some operation cases, the active pixel 900 can achieve the CDS function while keeping the transistor 911 (TX3) off.

Please refer to FIG. 9 in conjunction with FIG. 8. FIG. 9 is a diagram illustrating various steps of the active pixel 900 in FIG. 8 to operate without SESA operation. For clear understanding of the process flow shown in FIG. 9, a brief structure of the active pixel 900 is illustrated at the top of the diagram.

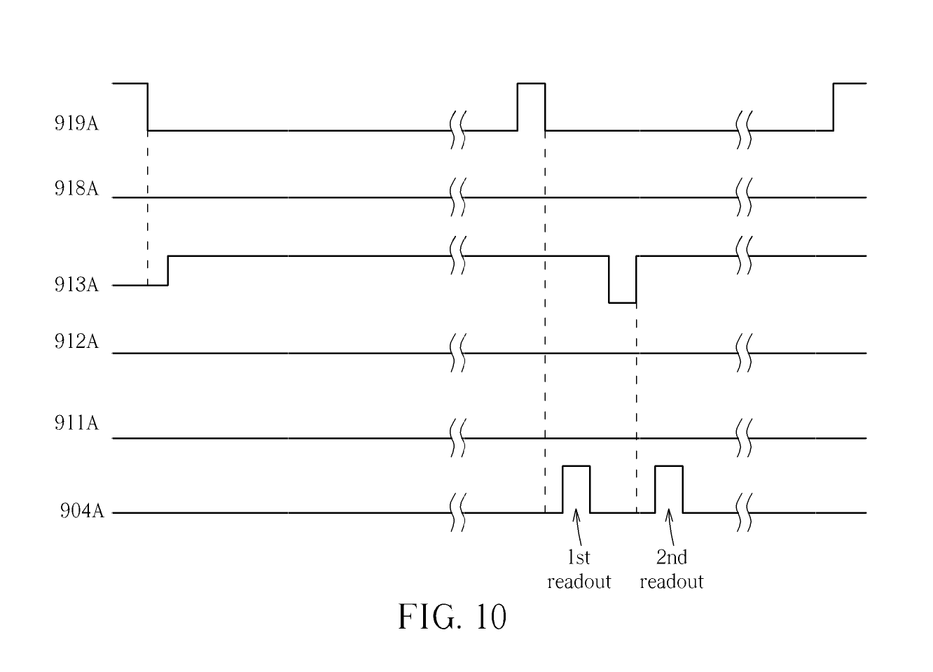

Please refer to FIG. 10 in conjunction with FIG. 8 and FIG. 9. FIG. 10 is a timing diagram illustrating a plurality of signals according to an embodiment of the active pixel 900 with respect to the process steps shown in FIG. 8, including a reset signal 919A applied to the gate of the reset transistor 919, a signal 918A applied to the gate of the transfer transistor 918, a signal 913A applied to the gate of the transistor 913, a signal 912A applied to the gate of the transfer transistor 912, a signal 904A applied to the gate of the row select transistor 904, and a voltage Va. Where a signal 911A illustrates the signal applied on the gate of the transistor 911A.

Please refer to FIG. 8, FIG. 9 in view of FIG. 10. As shown in FIG. 9, in the following steps the photodiode 914 is fully depleted with a pinning voltage Vpin. In step S1001, the reset transistor 919 turns on since the voltage signal 919A is set to be high. After the first reset operation, the active pixel 900 starts integration (Step 1002).

In step S1002, a plurality of photo-generated charges are integrated. The reset transistor 919 is turned off and the voltage V_{STO} (i.e., the voltage at the gate of the storing transistor 913) pulls up. In this step, a potential well is formed to store the charges collected by the fully depleted photodiode 914. As shown in FIG. 9, some noise n1 is left at the outputting node 922 after resetting, but a first readout of the pixel 900 is not affected by the noise n1 since the transfer transistor 918(TX1) is acted as a barrier of the storing node 917.

In FIG. 9, in step S1003, the integration is ended and the outputting node 922 is reset again by turning on the reset transistor 919. In step S1004, the reset transistor 919 turns off and then the first readout occurs. The sampled noise n2 left at the outputting node 922 during step S1003, and the sampled value of the noise signal n2 is stored in the readout circuit (not shown) for the CDS operation.

In step S1005 in FIG. 9, the charges are transferred and a second readout takes place. The storing transistor 913 turns off for transferring the stored charges from the storing node 917 to the outputting node 922. The charges at the outputting node 922 are induced by the signal and the second reset noise n2. In the end, a readout follows charge transfer and samples that value. Using the sampled value in step S1004, the signal value can be extracted.

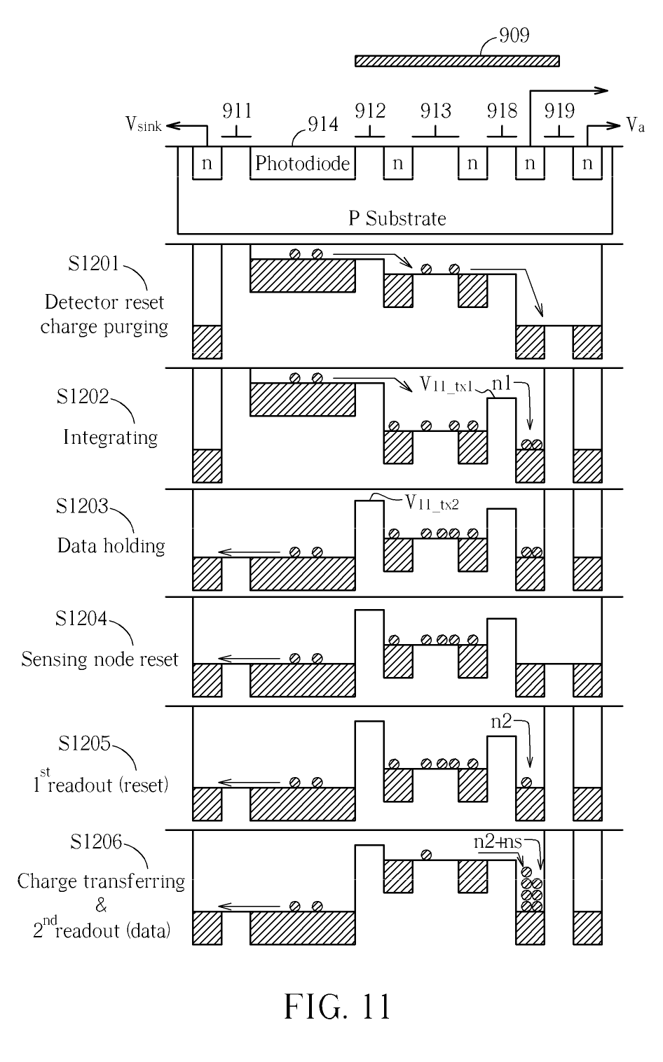

The gate of the transfer transistor 918(TX1) may be held at a specified constant voltage V₁, and the gate of the second transfer transistor 912 may be held at another specified constant voltage V₂, for minimizing any switching noise. However, in another embodiment shown in FIG. 11, the applied voltage on the gate of the transfer transistor 912(TX2) pulls down in step S1203 to ensure an effective barrier between the sensing node 914A and the storing node 917. The alternative designs obey and fall into the scope of the present invention.

In the descriptions above, the active pixel 900 operates with CDS when no SESA required is disclosed, In other words, the foregoing operation may be conducted in a “row-rolling” manner, since there is no SESA function.

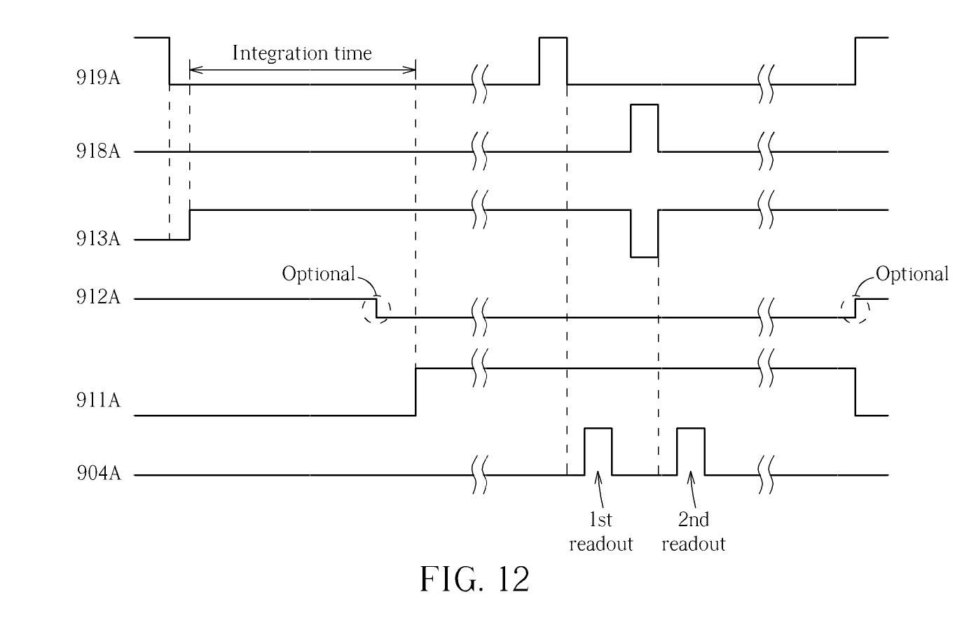

Please refer to FIG. 11 in conjunction with FIG. 8; FIG. 11 a diagram illustrating various steps that may be used for the active pixel 900 to operate with both the CDS function and the SESA function according to one aspect of the present invention. For clear understanding of the process flow shown in FIG. 11, a brief structure of the active pixel 900 is shown at the top of the diagram. FIG. 12 is a timing diagram illustrating a plurality of signals according to an embodiment of the active pixel 900 with respect to the process steps shown in FIG. 11, including a reset signal 919A applied to the gate of the reset transistor 919, a signal 918A applied to the gate of the transfer transistor 918(TX1), a signal 913A applied to the gate of the storing transistor 913, a signal 912A applied to the gate of the transfer transistor 912(TX2), a signal 904A applied to the gate of the row select transistor 904 and a voltage Va.

Steps S1201, S1202, S1204, S1205, and S1206 in FIG. 11 are similar to steps S1001, 1002, S1003, S1004, and S1005 respectively, as described above with respect to FIG. 9.

In brief, at step S1201, the reset transistor 919 turns on for a first resetting, and before the step S1202 the reset transistor 919 turns off. In step S1202 the storing transistor 913 turns on and the photodiode 914 in this embodiment is fully depleted photodiode so that the generated charges will successfully store in the storing node 913. In a preferred embodiment, at the end of the integration, the voltage applied on the transfer transistor 912 (TX2) is slightly heaved to further enhance the barrier between the sensing node 914A and the storing node 917. in step 1203, since the pixel 900 is operated with both SESA and CDS, the voltage signal 911A of the transfer transistor 911 (TX3) is down during the data holding for drain out the remnant charges at the sensing node 914A. Since the voltage signal 912A of the second transfer transistor is heaved at step S1203 and the photodiode 914 is shorted to a voltage Vₛᵢₙₖ since the third transfer transistor 911 is on, any additional photo-generated charges are drained by the voltage Vₛᵢₙₖ. Data associated with any captured exposure is stored under the gate of the storing transistor 913. The potential barrier created by the transfer 912(TX2) and the light shield 909 prevents the stored data from being interfered with by any incoming signal, and the charge sink 910 formed by the third transfer transistor 911 (TX3) and the voltage Vₛᵢₙₖ. This combination allows all pixels in an area array to stop integration simultaneously, and hold the data until readout and hence efficiently facilitates SESA operation.

In step S1204, the reset transistor 919 turns on again for reset. In step S1205, after the reset transistor 919 turns off, the row select transistor 904 turns on for achieve first read out. At step S1206, the transfer transistor 918 turns on and the storing transistor 913 turns off for transferring the charges from the storing node 917 to the outputting node 922; after the charge transfer the transfer transistor 918(TX1) turns off and then the row select transistor 904 turns on for the second readout. It is noteworthy that steps S1204-S1206 (also steps S1003-S1005) are performed in a “rolling” manner, i.e., sequentially row after row, until the last row is reached.

Operations for one row of the pixel array are finished from the aforementioned steps. After the readout operations of all the rows within the pixel array end (a readout operation of a frame), the transfer transistor 911 (TX3) is turned off and the reset transistor 919 is turned on for the follow-up frames. Since the photodiode 914 is a fully depleted photodiode in this embodiment; this ensures that all incoming charges are transferred to the storage node 917, instead of staying in the photodiode 914.

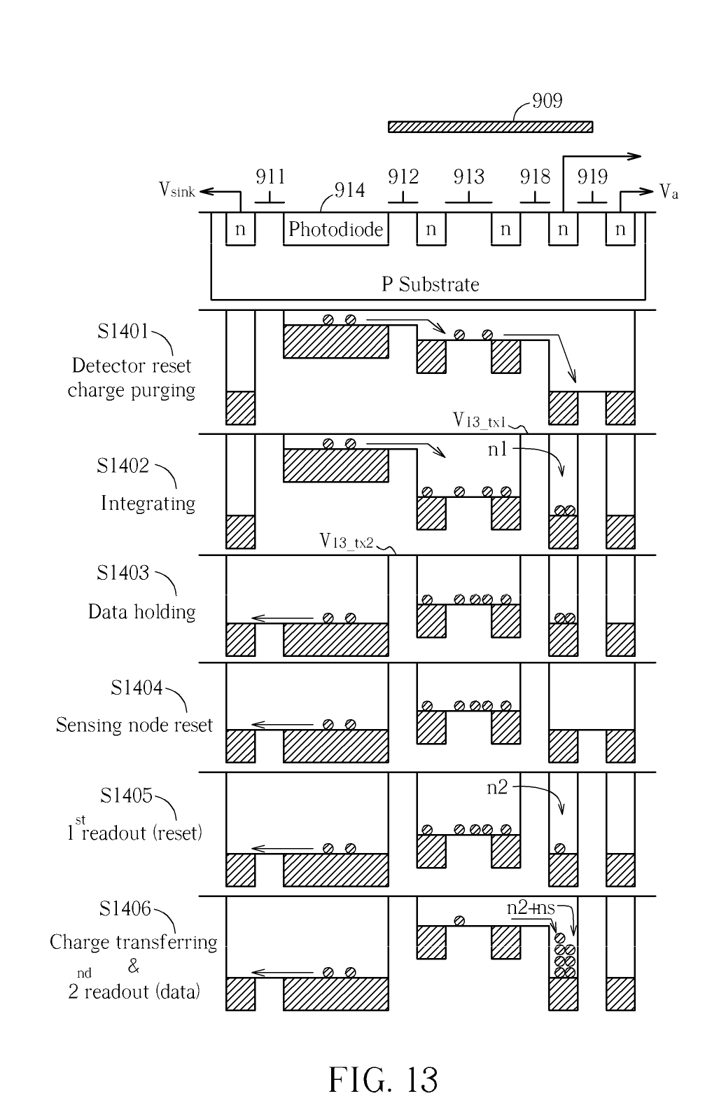

It should be noted that the present invention is not limited to the foregoing implementations. Various modifications may be used to implement the foregoing techniques. For example, the potential barrier formed by the transfer transistors 918(TX1), the transfer transistor 912(TX2), and the transfer transistor 911 (TX3) may be operated differently than as described above. An example of such a variation is provided with respect to the diagram shown in FIG. 13.

The steps S1401-S1407 of FIG. 13 correspond to steps S1201-S1207 of FIG. 11, respectively. Referring to FIG. 13, step S1401 is similar to step S1201 of FIG. 11.

In step S1402, the voltage applied on the gate of the first transfer transistor 918(TX!) is biased at a voltage V₁₃_{_{—}}ₜₓ₁ lower than a voltage V₁₁_{_{—}}ₜₓ₁, as shown in FIG. 13 and FIG. 11. The lower voltage of the first transfer transistor 918(TX1) can fully turn off the first transistor 918(TX1). The applied voltage on the gate of the first transfer transistor 918(TX1) therefore stays at this voltage V₁₃_{_{—}}ₜₓ₁ until step S1406 is executed, where step S1406 is similar to step S1206 mentioned above.

As for the applied voltage on the transfer transistor 912(TX2), the gate of the transfer transistor 912(TX2) is biased at a voltage V₁₃₋ₜₓ₂ lower than a voltage V₁₁_{_{—}}ₜₓ₂(FIG. 11 and FIG. 13) as the process enters the data holding step S1403 which is similar to step S1203 mentioned above. The voltage applied on the gate of the transfer transistor 912(TX2) stays at this voltage V₁₃₋ₜₓ₂ after step S1406 is finished.

According to one aspect of the present invention, an active pixel with a plurality of separate nodes for signal detecting, storing and outputting, a charge sink, and an area-array is provided. The active pixel is capable of efficiently performing SESA in the CMOS area.

According to another aspect of the present invention, an active pixel can perform Correlated Double Sampling (CDS) by using a “spill well” structure. The photo detector of the present invention has higher quantum efficiency than those using CCD and photogate types of pixels.

According to yet another aspect of the present invention, an active pixel and an area-array of such a pixel can perform both SESA and CDS simultaneously. The spill well structure which uses a photodiode as the photo detector helps to achieve higher quantum efficiency than those using CCD and photogate types of pixels. In a preferred embodiment, the photodiode is a fully depleted photodiode. Furthermore, the present invention is compatible with standard CMOS process.

Those skilled in the art will readily observe that numerous modifications and alterations of the device and method may be made while retaining the teachings of the invention.

What is claimed is:

1. An electronic image sensor with a pixel array of a plurality of active pixels, each of the active pixels comprising:
a photo detector, providing a sensing node for producing a signal based on an amount of light incident thereon;
a storing node for storing a plurality of photo-generated charges according to the signal;
a first controllable potential barrier between the sensing node and the storing node;
an outputting node; and
a second controllable potential barrier between the storing node and the outputting node, wherein each of the sensing node, the storing node and the outputting node is not overlapped.

2. The electronic image sensor of claim 1, wherein the photo detector is a fully depleted photodiode.

3. The electronic image sensor of claim 2, wherein the first controllable potential barrier and the second controllable potential barrier are selectively coupled to a source external to the pixel array, respectively.

4. The electronic image sensor of claim 2, wherein each of the active pixels further comprises:
a charge sink, operationally coupled to the photo detector and a voltage source, the charge sink providing a sinking node for draining photo-generated charges and providing a third controllable potential barrier between the photo detector and the voltage source.

5. The electronic image sensor of claim 4, wherein the charge sink and the voltage source are shared by multiple active pixels.

6. The electronic image sensor of claim 2, wherein the storing node is operationally controlled by an external signal to transfer charges.

7. The electronic image sensor of claim 1, wherein the pixel array comprising a source follower transistor and a row select transistor, and the source follower transistor and the row select transistor are shared by multiple active pixels.

8. A method for correlated double sampling in an electronic image sensor with a pixel array of a plurality of active pixels each having a photo detector, the method comprising:
integrating a plurality of photo-generated charges;
resetting a signal sampling node;
sampling noise at a first readout;
transferring the photo-generated charges to the signal sampling node; and
obtaining a second read out with charge sampling to extract a signal accordingly.

9. The method of claim 8, wherein the photo-generated charges are integrated after a potential well is formed.

10. The method of claim 8, wherein the first readout is to sample noise left at the signal sampling node.

11. A method for correlated double sampling, snapshot and simultaneous electronic shutter action (SESA) in an electronic image sensor with a pixel array of active pixels each having a photo detector for producing a signal based on an amount of light incident on the pixel array, the method comprising:
integrating a plurality of photo-generated charges according to the signal;
holding the photo-generated charges until a readout;
turning on a charge sink for draining a plurality of incoming photo-generated charges;
resetting a signal sampling node;
sampling noise at a first readout;
transferring the photo-generated charges to the signal sampling node; and
turning off the charge sink for pre-resetting a plurality of nodes.

12. An imaging system with an electronic image sensor having a pixel array of a plurality of active pixels, each of the active pixels comprising:
a photo detector, providing a sensing node for producing a signal based on an amount of light incident thereon;
a storing node for storing a plurality of photo-generated charges according to the signal;
a first controllable potential barrier between the sensing node and the storing node;
an outputting node; and
a second controllable potential barrier between the storing node and the outputting node, wherein each of the sensing node, the storing node and the outputting node is not overlapped.

13. The imaging system of claim 12, wherein the photo detector is a fully depleted photodiode.

14. The imaging system of claim 12, wherein the first potential barrier and the second potential barrier are coupled to a source external to the image pixel array, respectively.

15. The imaging system of claim 12, wherein each of the active pixels further comprises:
a charge sink, operationally coupled to the photo detector and a voltage source, the charge sink providing a sinking node for draining photo-generated charges and providing a third controllable potential barrier between the photo detector and the voltage source.

16. The imaging system of claim 15, wherein the charge sink and the voltage source are shared by multiple active pixels.

17. The imaging system of claim 12, wherein the storing node is operationally controlled by an external signal to transfer charges.

18. The imaging system of claim 12, wherein the pixel array comprising a source follower transistor and a row select transistor, and the source follower transistor and the row select transistor are shared by multiple active pixels.
